(19) United States
(12) Patent Application Publication
(10) Pub. No.: US 2003/0051983 A1
(43) Pub. Date: Mar. 20, 2003

(54) Membrane keyswitch for an expandable keyboard and an expandable keyboard device

(76) Inventor: Roy J. Lahr, Los Angeles, CA (US)

Correspondence Address: KENYON & KENYON, ONE BROADWAY, NEW YORK, NY, 10004, US

(21) Appl. No.: 10/093,917

(22) Filed: Mar. 7, 2002

Related U.S. Application Data
(60) Provisional application No. 60/273,981, filed on Mar. 7, 2001.

(51) Int. Cl. H01H 13/70

(52) U.S. Cl. 200/5 A

(57) ABSTRACT

An expandable keyboard device includes an elastic belt and at least one keyswitch arranged on a side of the elastic belt. The keyswitch includes a first electrically conductive member and a second electrically conductive member, the first electrically conductive member and the second electrically conductive member configured to be contacted to activate the keyswitch. At least one of the first electrically conductive member and the second electrically conductive member is configured to be expanded in at least one dimension. Another expandable keyboard device includes an elastic belt, at least one keyswitch arranged on a side of the elastic belt and an arrangement configured to vector a force applied to a surface of the elastic belt toward the keyswitch. A keyswitch includes a first electrically conductive member and a second electrically conductive member. The first electrically conductive member and the second electrically conductive member are configured to be selectively contacted. At least one of the first electrically conductive member and the second electrically conductive member is configured to be expanded in at least one dimension.

### CROSS-REFERENCE TO RELATED APPLICATIONS

This application claims the benefit of U.S. Provisional Patent Application No. 60/273,981, filed on Mar. 7, 2001.

The present application is related to U.S. patent application Ser. No. 09/558,866, entitled “Expandable and Contractible Keyboard with Adjustable Key Sizes,” filed on Apr. 26, 2000, which claims the benefit of U.S. Provisional Patent Application No. 60/178,936, filed on Feb. 1, 2000, and relates to U.S. patent application Ser. No. 09/775,291, entitled “Expandable and Contractible Keyboard with Adjustable Key Sizes,” filed on Feb. 1, 2001, which is a continuation-in-part of U.S. patent application Ser. No. 09/558,866, filed on Apr. 26, 2000 and which claims the benefit of U.S. Provisional Patent Application No. 60/178,926, filed on Feb. 1, 2000, U.S. Provisional Patent Application No. 60/221,114, filed on Jul. 27, 2000, U.S. Provisional Patent Application No. 60/233,965, filed on Sep. 20, 2000 and U.S. Provisional Patent Application No. 60/255,295, filed on Dec. 13, 2000, each of which is expressly incorporated herein in its entirety by reference thereto.

### FIELD OF THE INVENTION

The present invention relates to a membrane keyswitch for an expandable keyboard and to an expandable keyboard device.

### BACKGROUND INFORMATION

In keyboard devices, it is common to use membrane keyswitches, which are relatively inexpensive. Such keyswitches may be sealed with a flexible overpack so that the keyswitch itself can withstand environmental hazards, such as spilled liquids, foreign matter, e.g., dirt, dust, crumbs, other debris, etc., and air-borne particles.

The construction of a conventional membrane keyswitch is illustrated in FIGS. 1 to 8. As illustrated in FIG. 1, keyswitch 10 is constructed of a plurality of layers 14, 16, 18 formed on a rigid base 12. Layer 14 is a semi-flexible conductor sheet, layer 16 is an insulator sheet having a central open region 20, and layer 18 is a flexible conductor sheet.

FIG. 2 is a cross-sectional view of the keyswitch 10 in an assembled state. As illustrated in FIG. 2, the assembled keyswitch 10 includes a sealing overpack 22, a first conductor 24 electrically connected to flexible conductor sheet 18 and a second conductor 26 electrically connected to conductor sheet 14. The first conductor 24 and the second conductor 26 are sealed by the sealing overpack 22.

FIG. 3 is a top plan view illustrating the conductor sheet 14, the insulator sheet 16 and the flexible conductor sheet 18.

The keyswitch 10 provides a single-pole, single-throw (SPST) switch. Operation of the keyswitch 10 is illustrated in FIG. 4. As illustrated in FIG. 4, pressure applied, e.g., by a fingertip, to the top surface of the conductor sheet 18 in the direction of arrow 28 moves a portion of the conductor sheet 18 toward the conductor sheet 14 in the region of the open region 20. Contact between the conductor sheet 18 and the conductor sheet 14, as illustrated in FIG. 4, provides electrical connection between the first conductor 24 and the second conductor 26. Such electrical connection is decoded by the logic circuitry of the keyboard.

Operation of an alternative arrangement of keyswitch 10 is illustrated in FIG. 5. As illustrated in FIG. 5, the conductor sheet 14 is split into first portion 14a and second portion 14b. First conductor 24 is electrically connected to first portion 14a, and second conductor 26 is electrically connected to second portion 14b. Thus, pressure applied, e.g., by a fingertip, in the direction of arrow 28 to the top surface of conductor sheet 18 deforms the conductor sheet 18 to contact the first portion 14a and the second portion 14b. The contact between the conductor sheet 18 and the first portion 14a and the second portion 14b, as illustrated in FIG. 5, provides electrical connection between the first conductor 24 and the second conductor 26. Such electrical connection is decoded by the logic circuitry of the keyboard. FIG. 6 is a top plan view of the keyswitch 10 illustrated in FIG. 5.

It is an object of the present invention to provide a membrane keyswitch suitable for use in conjunction with an expandable keyboard device.

It is another object of the present invention to provide an expandable keyboard device.

### SUMMARY

The above and other beneficial objects of the present invention are achieved by providing a membrane keyswitch and an expandable keyboard device as described herein.

According to one example embodiment of the present invention, an expandable keyboard device includes an elastic belt and at least one keyswitch arranged on a side of the elastic belt. The keyswitch includes a first electrically conductive member and a second electrically conductive member, the first electrically conductive member and the second electrically conductive member configured to be contacted to activate the keyswitch. At least one of the first electrically conductive member and the second electrically conductive member is configured to be expanded in at least one dimension.

According to another example embodiment of the present invention, an expandable keyboard device includes an elastic belt, at least one keyswitch arranged on a side of the elastic belt and an arrangement configured to vector a force applied to a surface of the elastic belt toward the keyswitch.

According to yet another example embodiment of the present invention, a keyswitch includes a first electrically conductive member and a second electrically conductive member. The first electrically conductive member and the second electrically conductive member are configured to be selectively contacted. At least one of the first electrically conductive member and the second electrically conductive member is configured to be expanded in at least one dimension.

### BRIEF DESCRIPTION OF THE DRAWINGS

FIG. 1 is a cross-sectional view of the layers forming a conventional membrane keyswitch.

FIG. 2 is a cross-sectional view of the conventional membrane keyswitch in an assembled state.

FIG. 3 is a top plan view of the layers of the conventional membrane keyswitch illustrated in FIGS. 1 and 2.

FIG. 4 is a cross-sectional view illustrating an operation of the conventional membrane keyswitch illustrated in FIGS. 1 and 2.

FIG. 5 is a cross-sectional view illustrating an operation of another conventional membrane keyswitch.

FIG. 6 is a top plan view of the membrane keyswitch illustrated in FIG. 5.

FIG. 7 is a schematic cross-sectional view of an example embodiment of a keyboard device having a plurality of membrane keyswitches according to the present invention.

FIG. 8 is a schematic cross-sectional view of an example embodiment of one membrane keyswitch according to the present invention.

FIG. 9 is a schematic cross-sectional view of another example embodiment of a keyboard device having a membrane keyswitch according to the present invention in an unstretched or unexpanded state.

FIG. 10 is a schematic cross-sectional view of the keyboard device illustrated in FIG. 9 in a stretched or expanded state.

FIG. 11 is a schematic top plan view illustrating the layers of the membrane keyswitch of the keyboard device illustrated in FIGS. 9 and 10 in the unstretched or unexpanded state.

FIG. 12 is a schematic top plan view illustrating the layers of the membrane keyswitch of the keyboard device illustrated in FIGS. 9 and 10 in the stretched or expanded state.

FIG. 13 is a schematic top plan view of an overpack of the membrane keyswitch of the keyboard device illustrated in FIGS. 9 and 10.

FIG. 14 is a schematic cross-sectional view of another example embodiment of a keyboard device having a membrane keyswitch according to the present invention in an unstretched or unexpanded state.

FIG. 15 is a schematic cross-sectional view of the example embodiment of the keyboard device illustrated in FIG. 14 in a stretched or expanded state.

FIG. 16 is a schematic top plan view of a pair of adjacent keyswitches according to the present invention.

FIG. 17 is a schematic top plan view of another example embodiment of a keyboard device according to the present invention.

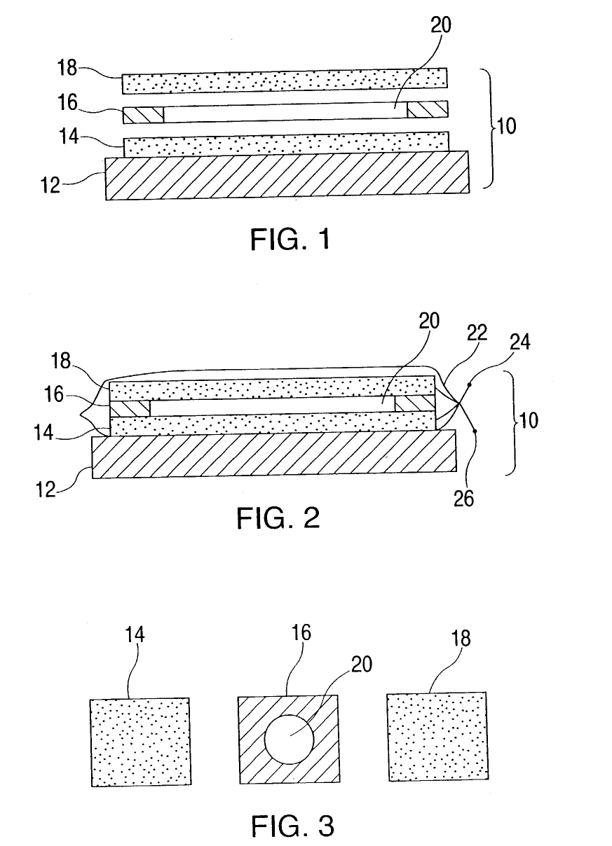

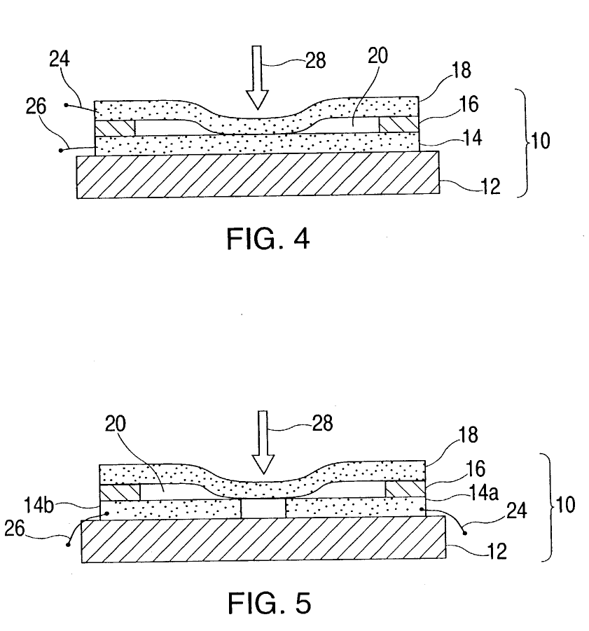

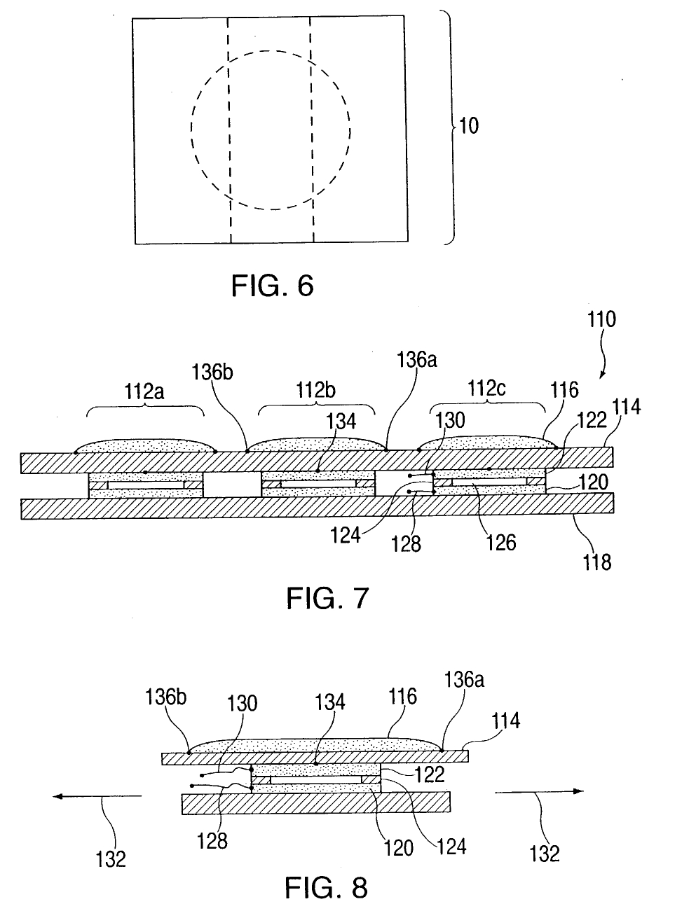

### DETAILED DESCRIPTION

FIG. 7 is a schematic cross-sectional view of an example embodiment of a keyboard device 110 according to the present invention. The keyboard device 110 includes a plurality of membrane keyswitches 112a, 112b, 112c according to an example embodiment of the present invention. Although FIG. 7 illustrates three membrane keyswitches 112a, 112b, 112c, it should be understood that keyboard device 110 may include any number of membrane keyswitches. For clarity and simplicity, each keyswitch 112a, 112b, 112c is referred to by reference character 112 where appropriate. As illustrated in FIG. 7, the keyswitch 112 is arranged below an elastic belt 114, which, as illustrated, has not been expanded laterally. A keycap 116, corresponding to each keyswitch 112, is arranged above the elastic belt 114 and above the corresponding keyswitch 112. The keycap 116 may be flexible. The keyswitch 112 includes a plurality of layers, including a first conductor sheet 120, an insulator sheet 124 having a central open region 126 and a second conductor sheet 122. A first contact 128 is electrically connected to the first conductor sheet 120, and a second contact 130 is electrically connected to the second conductor sheet 122. The first contact 128 and the second contact 130 are electrically and logically connected to logic circuitry of the keyboard device 110. Pressure applied, e.g., by a fingertip, to the keycap 116 toward the keyswitch 112 causes the keycap 116, the elastic belt 114 and the second conductor sheet 122 to deform, causing contact between the first conductor sheet 120 and the second conductor sheet 122. Such contact between the first conductor sheet 120 and the second conductor sheet 122 provides electrical connection between the first contact 128 and the second contact 130. A center portion of an upper side of the second conductor sheet 122 may be bonded to an underside of the elastic belt 114 by, e.g., a narrow tack strip 134, and the keycap 116 may be bonded on the top surface of the elastic belt 114 at the lateral ends 136a, 136b of the keycap 116.

FIG. 8 is a schematic cross-sectional view of keyboard device 110 in a condition in which the keyboard device 110 is stretched laterally in the direction of arrows 132. Because the membrane keyswitch 112 has a fixed size and is affixed to the elastic belt 114 by the narrow tack strip 134, adjacent keyswitches 112 are spaced at even intervals by lateral movement. Because the keycap 116 is attached at its lateral ends 136a, 136b to the elastic belt 114, the keycap 116 expands in accordance with the expansion of the elastic belt 114. Thus, a larger lateral width of the keycap 116 results in accordance with the expansion of the elastic belt 114 with the expanded keycaps 116 being arranged on the elastic belt 114 in accordance with the expansion of the elastic belt 114.

As illustrated in FIG. 8, the expanded, or stretched, keycap 116 is significantly wider than the underlying and corresponding keyswitch 112. If pressure, e.g., by a fingertip, is applied to an end of the keycap, the applied pressure may not operate the keyswitch 112, i.e., the pressure applied may not cause contact between the first conductor sheet 120 and the second conductor sheet 122 and therefore not cause electrical connection between the first contact 128 and the second contact 130. If a relatively narrow keyswitch 112 is provided to permit a very compressed or contracted width of the unstretched elastic belt 114, it is possible that a mispositioned point of pressure application, e.g., by a fingertip, will not activate the corresponding keyswitch 112.

A membrane keyswitch 212 may be provided that is formed of expandable materials so that the membrane keyswitch 212 is expandable in size. While the membrane keyswitch 212 may be expandable in two dimensions, e.g., width and length, the membrane keyswitch 212 may be expandable in a single dimension, e.g., width or length. For clarity and simplicity, membrane keyswitch 212 is described below as expandable with reference to a single dimension, e.g., laterally. It should be understood, however, that the membrane keyswitch 212 may also be expandable in two dimensions.

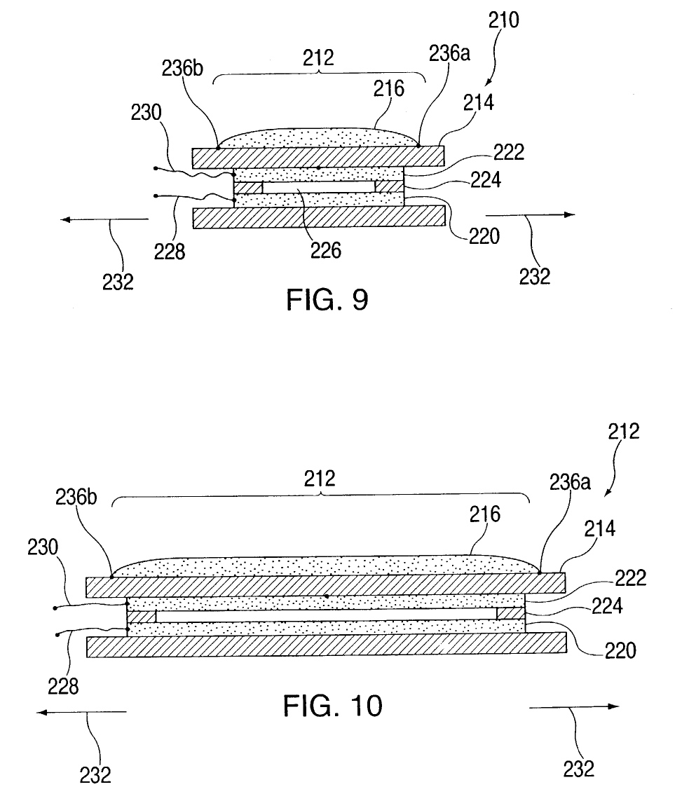

FIG. 9 is a schematic cross-sectional view of another example embodiment of a keyboard device 210 according to the present invention. The keyboard device 210 includes a membrane keyswitch 212 according to the present invention. Although FIG. 9 illustrates a single membrane keyswitch 212, it should be understood that keyboard device 210 may include any number of keyswitches 212. Keyswitch 212 includes a first conductor sheet 220, an insulator sheet 224 and a second conductor sheet 222. The first conductor sheet 220 and the second conductor sheet 222 may be formed of a conductive foam material, which may have a thickness of, e.g., 1/16″. While the conductive foam material may have a lower conductivity than a solid film layer, the conductivity of the conductive foam is sufficient to permit the logic circuitry of the keyboard device 210 to detect contact between the first conductive sheet 220 and the second conductor sheet 222, via the electrical connection between the first contact 228 and the second contact 230, which are respectively connected to the first conductor sheet 220 and the second conductor sheet 222. Contact resistance for a conductive foam material may be, for example, approximately 2 ohms, whereas a solid conductive film may have a contact resistance of, for example, 0.5 ohms. The foam material of the first conductor sheet 220 and the second conductor sheet 222 may permit the first conductor sheet 220 and the second conductor sheet 222 to be stretched or expanded laterally in the direction of arrows 232. FIG. 9 illustrates the keyswitch 212 in an unstretched or unexpanded state.

The keyswitch 212 includes an insulator layer 224, which may also be formed of a foam material, which has a thickness of, for example, 3/32″. The center open region 226 of the insulator layer 224 in the unstretched or unexpanded state may be, for example, circular. If stretched or expanded in one dimension, e.g., in the direction of arrows 232, the circular shape of the open region 226 may become, e.g., oval. The construction of keyswitch 212 from foam materials permits the keyswitch 212 to be stretched or expanded in at least one dimension, e.g., in the direction of arrows 232. FIG. 10 is a schematic cross-sectional view of the keyswitch 212 in the stretched or expanded state.

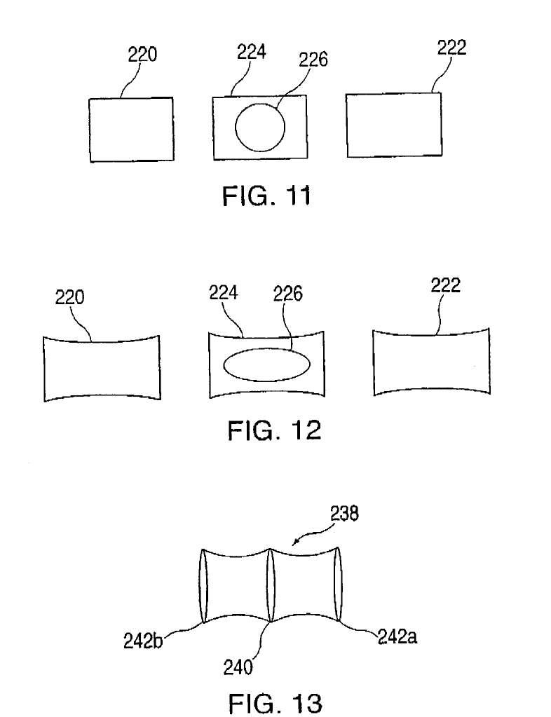

FIG. 11 is a schematic top plan view illustrating the first conductive sheet 220, the insulator sheet 224 and the second conductive sheet 222 of the membrane keyswitch 212 of the keyboard device 210 in the unstretched or unexpanded state, and FIG. 12 is a schematic top plan view illustrating the first conductive sheet 220, the insulator sheet 224 and the second conductive sheet 222 of the membrane keyswitch 212 of the keyboard device 210 in the stretched or expanded state

An overpack may be provided to seal the membrane keyswitch 212. The overpack may be formed of an expandable, stretchable or elastic material, e.g., thin synthetic rubber, a dental dam material, etc. The material of the overpack may have a thickness in the unexpanded or unstretched state of, e.g., 0.004″. The overpack may be formed of a material the permits easy pack sealing, e.g., by heating boundary zones of the overpack.

As illustrated in FIG. 12, stretching or expansion of the keyswitch 212 may cause shrinking or necking of the first conductive sheet 220, the insulator sheet 224 and the second conductive sheet 222. The open region 226 of the insulator sheet 224 may be elongated when stretched or expanded due to weakening of lateral column strength of the narrower edges on opposite sides of the open region 226. However, provided that the insulator sheet 224 maintains physical and electrical separation and isolation of the first conductive sheet 220 and the second conductive sheet 222, the keyswitch 212 may remain, e.g., normally open and operate properly.

FIG. 13 is a schematic top plan view of an overpack 238 of the membrane keyswitch 212. Overpack 238 may be held to the elastic belt 214 along a center stripe 240 and at the edges 242a, 242b. The overpack 238 may exhibit most of its vertical shrinking between the center stripe 240 and edge stripes 242a, 242b as illustrated in FIG. 13. This occurs because the elastic belt 214 may exhibit less vertical shrinkage because the elastic belt 214 may have a greater thickness than the thickness of the first conductive sheet 220, the insulator sheet 224, the second conductive sheet 222 and/or the overpack 238.

The elastic belt 114, 214 may be configured as a so-called “no-roll” elastic belt. Such no-roll elastic belts are available from Rhode Island Textile, Pawtucket, R.I. A no-roll elastic belt may include vertical gusset bars woven into the elastic belt. The gusset bars may provide greater strength vertically in comparison to a flat-woven elastic belt, such as that used, for example, for waistbands in clothing.

The elastic belt 114, 214 including the no-roll vertical gusset bar configuration may provide a larger expanded to unexpanded ratio. For example, a flat-woven elastic belt may provide, e.g., a 2-to-1 (expanded to unexpanded) ratio, whereas the no-roll elastic belt may provide, e.g., a 2.5-to-1 ratio or a 3-to-1 ratio if the weave is specifically tailored for maximum expansion.

As described above, lateral stretching or expansion of the elastic belt 212 causes corresponding stretching or expansion of the keycap 216 in the lateral direction, e.g., in the direction of arrows 232. The configuration of the first conductive sheet 220, the insulator layer 224 and the second conductive sheet 222 provides that the sensitive spot for the keyswitch 212 also stretches or expands laterally. Thus, pressure applied, e.g., by a fingertip, to a wider portion of the stretched or expanded keycap 216 properly activates the membrane keyswitch 212, i.e., contact is made between the first conductive sheet 220 and the second conductive sheet 222. Accordingly, even the off-center application of pressure, e.g., fingertip depression, will cause closure of membrane keyswitch 212.

Specifying variable width membrane keyswitches 212 may initially raise the production cost of an expandable keyboard device, since the technology of using foam or other laterally stretchable or expandable materials, e.g., the two conductive sheets 220, 222 and the insulator sheet 224, is different from the materials conventionally used in fabricating fixed size membrane switches.

Another force coupling arrangement may be alternatively or additionally provided to enable the use of a fixed size membrane keyswitch when the keytop is fabricated of a stretchable, expandable or elastic material so that the keytop may change width laterally when the elastic belt is stretched or expanded.

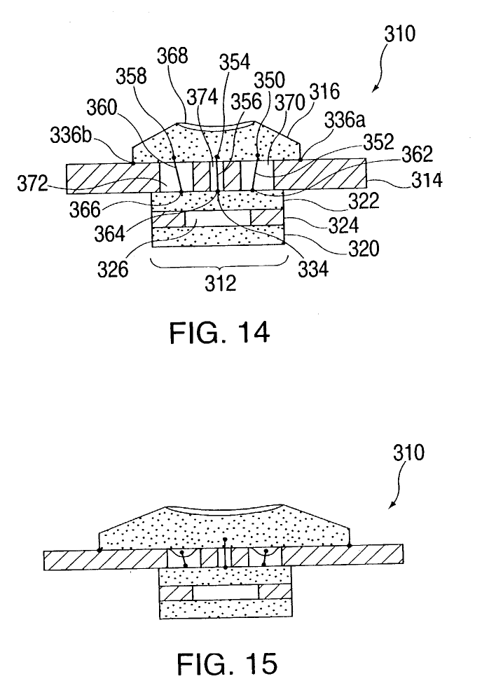

FIG. 14 is a schematic cross-sectional view of another example embodiment of a keyboard device 310 according to the present invention. Although FIG. 14 illustrates keyboard device 310 including a single membrane keyswitch 312 according to the present invention, keyboard device 310 may include any number of keyswitches 312. In keyboard device 310, an elastic keycap 316 is coupled at its ends 336a, 336b to an elastic belt 314 by, e.g., a heat melt glue or other attachment arrangement. The keycap 316 is configured to stretch or expand in accordance with the stretching or expansion of the elastic belt 314. Wells are formed on the underside of the keycap 316 to receive end structures 350, 354, 358, e.g., substantially spherical balls, formed on the end of bars 352, 356, 360, e.g., one central bar 356 and two side radius bars 352, 360. The end structures are held in the provided wells by, e.g., an adhesive, such as urethane. The other end structures 362, 364, 366 the bars 352, 356, 360 include, e.g., balls are attached to the encapsulating envelope around the fixed size membrane switch 312 by, e.g., an adhesive.

The upper surface 368 of the keycap 316 may be formed of a stiffer material to provide a stiff touch surface. The stiffness properties of this touch layer upper surface 368 may restrain the stretching or expansion of this upper surface 368, e.g., by 20%, so that the touch layer upper surface 368 will always be approximately, e.g., 20% narrower than the keycap 316. This arrangement may permit or encourages a central touch by, e.g., the fingertip, and these touch forces may be carried downward or transmitted through the keycap 316 to the upper surface of the fixed size membrane keyswitch 312. Thus, downward pressure, e.g., by a fingertip, will cause the conductive sheet 322 of the membrane keyswitch 312 to deform downwardly against the conductive sheet 320. Thus, switch closure of keyswitch 312 occurs as a result of a downward depression, e.g., by a fingertip, of the keycap 316.

When the elastic belt 314 is stretched or expanded, e.g., by approximately 150% and/or 300%, the keycap 316 is stretched or expanded correspondingly, with the stiffer upper touch surface 368 stretching or expanding a bit less due to the stiffness of the surface 368.

The radius bars 352, 360 on both sides of the central bar 356 may have a fixed length so when the keycap 316 is stretched or expanded laterally, the fixed length of the radius bars 352, 360 may tend to pull down the keycap 316 into the apertures 370, 372 formed in the elastic belt 314, e.g., the keycap 316 may bulge downwardly around the end structures 350, 358 of the radius bars 352, 360 as illustrated in schematic cross-section in FIG. 15. The angulated position of the end radius bars 352, 360 may tend to vector any downward force onto the upper surface of the membrane keyswitch 312 so as to cause switch closure. The apertures 370, 372, 374 in the elastic belt 314 may also enlarge in accordance with stretching or expansion of the elastic belt 314.

The apertures 370, 372, 374 may be formed in the elastic belt 314 by first coating the adjacent areas with a thin plastic layer. Either Tampon or silk screen printing may be used to accurately place the plastic layer in the desired areas. Depending on the sealing plastic used, it may be desirable or necessary to heat these selected plastic areas so that the plastic sinks into the elastic belt 314, e.g., a fabric, binding the threads locally.

A mechanical punch or laser, e.g., an excimer or CO₂ laser as used in the garment industry for cutting and edge sealing of fabrics, may be used to actually form the apertures 370, 372, 374 in the elastic belt 314 once the surrounding fibers have been secured to as to prevent runs, e.g., threads in the weave coming loose or being cut, in the woven fabric.

The flexible shape of the keycap 316 with a stiffer surface 368 in the central keytop depression may couple downward forces, e.g., applied by a fingertip, onto the central portion of the fixed-size membrane keyswitch 312 through the action of the bars 352, 356, 360, and this vectoring of, e.g., fingertip, force occurs despite the 100% to 300% lateral stretching or expansion of the size of elastic belt 314. The bulges that occur downward in the keycap 316 into the elastic belt apertures 370, 372 may tend to lock the keycap 316 onto the elastic belt 314 laterally so that the stiff keytop touch surface 368, keycap 316 and elastic belt 314 move downwardly when, e.g., a fingertip, depresses the touch surface 368.

The membrane keyswitch 312 may be affixed to the elastic belt 314 by a central strip 334, e.g., a glue bond, so that the membrane keyswitch 312 may always remain directly below the keycap 316 regardless of the stretching or expansion of the elastic belt 314.

This foregoing may ensure a reliable switch action by the membrane keyswitch 312 when fingertip depression of the touch surface 368 occurs. Note that the touch surface 368 may be embossed or patterned to help prevent finger skidding, even if the fingertip is not exactly in the center of the stiff touch surface 368. It may also be individually patterned so that the home row keys have a slightly different feel to improve home row location by the fingertips during touch typing.

While FIGS. 14 and 15 illustrate three bars 352, 356, 360, it should be understood that any number of bars, e.g., a single bar or a plurality of bars, may be provided to vector force from the keycap 316 to the membrane keyswitch 312.

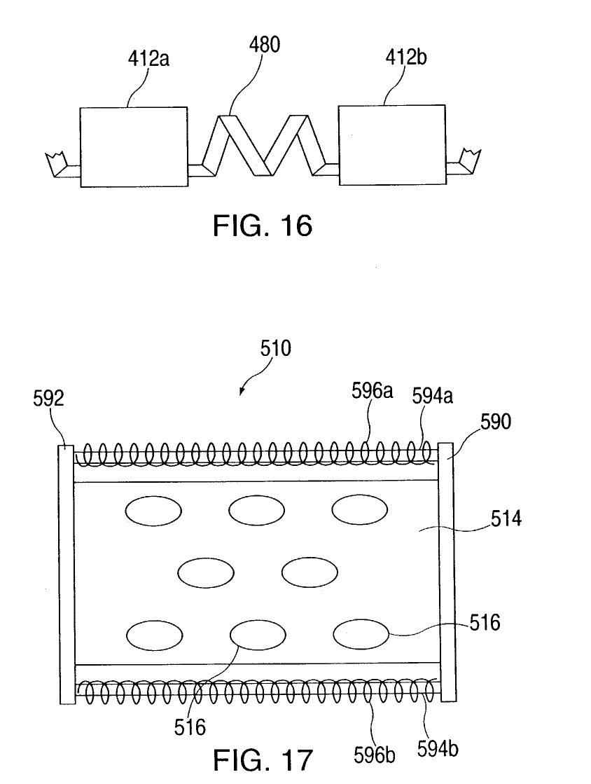

FIG. 16 is a schematic top plan view of a pair of adjacent keyswitches 412a, 412b. A flexible wiring arrangement 480 may be provided between the keyswitches 412a, 412b to provide electrical and logical communication between the keyswitches 412a, 412b and/or between logic circuitry of the keyboard device that includes the keyswitches 412a, 412b.

FIG. 17 is a schematic top plan view of another example embodiment of a keyboard device 510 according to the present invention. Keyboard device 510 includes a plurality of keycaps 516 arranged on a stretchable, expandable or elastic belt 514. Each keycap 516 corresponds to a respective membrane, or other, keyswitch. Opposite ends of the elastic belt 514 are connected to end plates 590, 592, and opposite ends of the end plates 590, 592 are connected via connection members 594a, 594b. The connection members 594a, 594b may be configured as, e.g., telescoping rods, telescoping boxes, etc. A spring 596a, 596b is arranged concentrically to each respective connection member 594a, 594b. The springs 596a, 596b are arranged to urge the end plates 590, 592 outwardly, e.g., away from each other, to compensate for the tendency of the elastic belt to urge the end plates 590, 592 toward each other.

What is claimed is:

1. An expandable keyboard device, comprising:
an elastic belt; and
at least one keyswitch arranged on a side of the elastic belt, the keyswitch including a first electrically conductive member and a second electrically conductive member, the first electrically conductive member and the second electrically conductive member configured to be contacted to activate the keyswitch, at least one of the first electrically conductive member and the second electrically conductive member configured to be expanded in at least one dimension.

2. The expandable keyboard device according to claim 1, further comprising an electrical insulator member arranged between the first electrically conductive member and the second electrically conductive member.

3. The expandable keyboard device according to claim 2, wherein the electrical insulator material is configured to be expanded in the at least one dimension.

4. The expandable keyboard device according to claim 1, wherein the at least one of the first electrically conductive member and the second electrically conductive member is formed of an elastic material.

5. The expandable keyboard device according to claim 1, wherein the at least one of the first electrically conductive member and the second electrically conductive member is formed of an electrically conductive foam material.

6. The expandable keyboard device according to claim 5, further comprising an electrical insulator material arranged between the first electrically conductive member and the second electrically conductive member.

7. The expandable keyboard device according to claim 6, wherein the electrical insulator material includes a foam material.

8. The expandable keyboard device according to claim 1, further comprising a spring device configured to exert a spring force against an elastic force of the elastic belt.

9. The expandable keyboard device according to claim 1, further comprising an arrangement configured to vector a force applied to a surface of the elastic belt toward the keyswitch.

10. An expandable keyboard device, comprising:
an elastic belt; and
at least one keyswitch arranged on a side of the elastic belt; and
an arrangement configured to vector a force applied to a surface of the elastic belt toward the keyswitch.

11. The expandable keyboard device according to claim 10, wherein the arrangement includes at least one bar having a first end connected to the elastic belt and a second end connected to the keyswitch.

12. A keyswitch, comprising:
a first electrically conductive member; and
a second electrically conductive member, the first electrically conductive member and the second electrically conductive member configured to be selectively contacted;
wherein at least one of the first electrically conductive member and the second electrically conductive member is configured to be expanded in at least one dimension.

13. The keyswitch according to claim 12, further comprising an electrical insulator material arranged between the first electrically conductive member and the second electrically conductive member.

14. The keyswitch according to claim 12, wherein at least one of the first electrically conductive member and the second electrically conductive member is formed of a electrically conductive foam.

15. The keyswitch according to claim 12, further comprising an expandable keycap connected to at least one of the first electrically conductive member and the second electrically conductive member, the keycap configured to cause contact between the first electrically conductive member and the second electrically conductive member in response to a force applied to the keycap.

16. The keyswitch according to claim 15, further comprising an arrangement configured to vector the force in a direction toward a contact region of the first electrically conductive member and the second electrically conductive member.

17. The keyswitch according to claim 16, wherein the arrangement includes at least one bar having a first end connected to the keycap and a second end connected to one of the first electrically conductive member and the second electrically conductive member.

18. The keyswitch according to claim 15, wherein the keycap is expandable in at least one dimension.
